(19) United States
(12) Patent Application Publication
(10) Pub. No.: US 2010/0029454 A1
(43) Pub. Date: Feb. 4, 2010

(54) Method and apparatus for bonding a sheet for a corrugated cardboard box

(75) Inventors: Taichi Tawada, Aichi (JP); Kenji Kuragake, Osaka (JP); Hiroshi Matsuzaki, Osaka (JP); Makoto Hosokawa, Osaka (JP); Kunihiko Morimoto, Osaka (JP); Hiroshi Yamaura, Osaka (JP)

Correspondence Address: BACON & THOMAS, PLLC, 625 SLATERS LANE, FOURTH FLOOR, ALEXANDRIA, VA, 22314-1176, US

(73) Assignees: Tawada Co., Ltd., Aichi (JP); Morimoto Mfg. Co., Ltd., Osaka (JP)

(21) Appl. No.: 12/457,975

(22) Filed: Jun. 26, 2009

(30) Foreign Application Priority Data
Jul. 30, 2008 (JP) 2008-196488

(51) Int. Cl. B31B 1/68; B31B 5/60; D05B 25/00

(52) U.S. Cl. 493/118; 493/261; 112/2

(57) ABSTRACT

A bonding apparatus according to the present invention relates to a sewing machine (28) which on stitching a connecting flap and a flap to be connected (hereafter referred to as only ‘connected flap’) of one unit, one set of two sheets for a corrugated cardboard box, ensures the folding of the connecting flap and the connected flap, inhibits the blind movement of the position, rectangular in section, of the sheets for the corrugated cardboard box when thread-stitching them, solves the load burdened on a looper mechanism, and provides an appropriate thread-stitching work. The sewing machine (28) comprises a sewing-machine needle mechanism (28b) provided with a sewing-machine needle (28a) and the looper mechanism (28d) having a needle plate (28c). This sewing machine (28) arranges the needle plate (28c) of the looper mechanism (28d) inside the connecting flap (12a) and the sewing-machine needle mechanism (28b) outside the connected flap (12b) and holds the position, rectangular in section, of the both sheets (W1. W2) of the corrugated cardboard box and intermittently moves them in parallel to the first folding line (10) and synchronizes the sewing-machine needle (28a) with the intermittent movement to reciprocally move it horizontally from the outside to the inside of the threading portion (S) so as to stitch the threading portion with threads.

### BACKGROUND OF THE INVENTION

1. Field of the Invention

The present invention relates to a method for bonding a connecting flap of a sheet for a corrugated cardboard box to another flap to be connected by thread-stitching and an apparatus therefor.

Particularly, the present invention concerns a sheet for a large-sized corrugated board box. In other words, it is directed to boding sheets for a corrugated cardboard box, which comprise one unit comprising one set of two sheets, split into two pieces.

2. Description of the Prior Art

A conventional example of this type has adopted traditionally an apparatus and a method, so-called “wire-stitching”, for bonding a connecting flap of one of two sheets in one unit for a corrugated cardboard box to a flap to be connected (hereafter referred to only as ‘connected flap’) of the other sheet (see Japanese Patent Publication No. Sho 52-29667).

This conventional example discloses a method and an apparatus each of which feeds one sheet for a corrugated cardboard box to an upper guide bar and another sheet to a lower guide bar and bending the corrugated cardboard box sheets along preliminarily provided folding lines through the guide bars to provide a framework rectangular in section and then bond bonding portions, each of which comprises the connecting flap and the connected flap, sequentially by a wire stitcher.

This conventional example bonds the bonding portion by a wire. Therefore when it is utilized for reuse, the existence of the wire becomes an obstacle to cause a trouble for removing it and besides when using it, the wire comes into contact with the human's body to damage it or the material to be packed. Further, the clothing's are not rarely damaged.

Additionally, the framework in rectangular in section is provided by bending the sheets along the folding lines through the guide bards. However, it is liable to lack reliability of the folding and preciseness as to the position-control of the framework.

Then, recently, instead of the wire-bonding, an adhesive-bonding, so-called ‘glue-joint’ has taken a main place and therefore various sorts of bonding methods and apparatus have been developed. However, the adhesive-bonding requires the bonding step, the heating step and the drying step and as a result invites an increase of number of steps. This has entailed an insufficient production efficiency.

Under the above circumstances, in attempt to solve the problems the conventional examples have caused, there have been developed a method and an apparatus for bonding the bonding portion by thread-stitching (Japanese Patent Application Laid-Open No. 2006-175157).

According to this example, a sheet for corrugated cardboard box is manually bent into a shape rectangular in section through folding lines. A connecting flap is supported below a base pedestal and a connected flap is supported above the base pedestal to constitute a bonding portion, which consists of the connecting flap and the connected flap, vertically held with the base pedestal interposed therebetween. When the bonding portion is stitched with threads such as staple fibers by moving a sewing-machine needle up and down, a sheet for corrugated cardboard box is extracted out of the base pedestal downwards of the sewing-machine needle and subsequently the bonding portion is thread-stitched.

In consequence, good valuation can be given to this example in that it has solved the problems the above-mentioned respective prior arts have suffers from.

On the other hand, it may cause only a little problem as to a sheet for a light corrugated cardboard box of a relatively small and standard size since it stitches the bonding portion with threads by moving the sewing-machine needle up and down.

However, provided that a sheet for a large-sized corrugated cardboard box (for example, the sheet is 5,200 mm in length and 1,200 mm in width, and weights 4,100 g) is tried to be bonded by a sheet for corrugated cardboard box, it poses a problem of not only taking trouble on thread-stitching, but also greatly increasing a working space. Besides, it is impossible to prevent the load from being burdened.

The load of the sheet is applied to a case housing a needle plate and a looper and as a result the needle plate and the case are bent or deformed to cause disorder in the relationship of position between the needle, the looper and the needle plate. This has degraded the reliability of the thread-stitching.

Thus the inventors have clarified by tests that it is difficult to stitch the sheet for the large-size corrugated cardboard box by a sheet for corrugated cardboard box.

Further, although a Utility Model recited in Japanese Registered Utility Model No. 3142579 has been developed, as far as it concerns a sheet for a light corrugated cardboard box of relatively small and standard size, it has caused only a little problem, but as for a sheet for a large and heavy corrugated cardboard box, it has caused problems as mentioned above, as well as the invention stated in Japanese Patent Application Laid-Open No. 2006-175157.

Further, the above-mentioned Japanese Patent Publication No. Sho 52-29667 and Japanese Registered Utility Model No. 3142579 have not yet solved the problem to provide a generally usable apparatus and method, on bonding the sheet for a large-sized corrugated cardboard box, i.e. the theme of the invention of each of those prior arts, which can attend in correspondence with every size of the sheet for corrugated cardboard box, either large or small, as regards the bonding by one specific bonding apparatus, although needles to say it is necessary to bond the sheet for corrugated cardboard box, either large or small, among the group of large-sized corrugated cardboard boxes.

### SUMMARY OF THE INVENTION

The problem to be solved can be seen in view of the above-mentioned ones. The present invention has an object to provide a method and an apparatus for bonding a sheet for a large-sized corrugated cardboard box, which can ensure the reliability of folding so as to obtain the connecting flap and the connected-flap side sheet and can prevent the load of the sheet from being applied to the case housing the needle plate and the looper and inhibit the bending or deforming of the needle plate and the case as well as the disorder of the relationship of position between the needle, the looper and the needle plate.

Another object is to provide a method and an apparatus generally usable for bonding purpose, which can attend in correspondence with every size of the sheet for corrugated cardboard box either large or small, on bonding the sheets for corrugated cardboard box either large or small, which is the theme of the present invention.

A first means for solving the problem of the present invention is to provide a method for bonding the connecting flap and the connected flap of the sheet for corrugated cardboard box with threads. This method comprises:

providing one set of two sheets for a corrugated cardboard box, in which a connecting flap projects on one side with a first folding line taken as a boundary and the connected flap corresponding to the connecting flap is formed on a rear surface of the other side, a second folding line being formed between the connecting flap and the connected flap, a connecting-flap side sheet being provided between the first folding line and the second folding line and the connected-flap side sheet being provided between the second folding line and the connected flap;

arranging one sheet for the corrugated cardboard box above in a horizontal state and the other sheet for the corrugated cardboard box symmetric with respect to one of the sheets for the corrugated cardboard box and therebelow in the horizontal state and maintaining both of the above-mentioned sheets at their positions thus arranged;

bending the connecting flap of one of the sheets for the corrugated cardboard box at right angles downwardly with the first folding line taken as a boundary and the connecting flap of the other sheet for the corrugated cardboard box at right angles upwardly with the first folding line taken as a boundary and bending the connected-flap side sheet of one of the sheets for the corrugated cardboard box at right angles downwardly with the second folding line taken as a boundary and the connected-flap side sheet of the other sheet for the corrugated cardboard box at right angles upwardly with the second folding line taken as a boundary to form the position of the both sheets of the corrugated cardboard box into a shape rectangular in section;

setting threading portions, each of which comprises the connecting flap and the connected flap opposed to one another on a diagonal line, and retaining their positions as they are so set;

arranging two sets of sewing machines, each of which comprise a sewing-machine needle mechanism provided with a sewing-machine needle movable in a horizontal direction and a looper mechanism having a needle plate, beside the threading portions, respectively;

setting the needle plate of the looper mechanism inside one of the threading portions and the sewing-machine needle mechanism outside the other of the threading portions;

intermittently moving the both sheets for the corrugated cardboard box, formed rectangular in section, in parallel to the first and the second folding lines and synchronizing the sewing-machine needle with the intermittent movement to reciprocally move it from the outside to the inside of a threading portion in the horizontal direction so as to stitch the threading portion with threads.

The first solution attempted not to expose the connecting flap in outer appearance by setting the connecting flap inside the connected flap. However, if the outer appearance is negligible, it is free to bend the connected flap inside the connecting flap to the contrary.

A second means for solving the problems relates to an apparatus for bonding the sheet for corrugated cardboard box. This apparatus comprises an upper transporting means and a lower transporting means which vertically divide one set of two sheets for corrugated cardboard box to an upper one and a lower one and transporting them in a horizontal direction, in the one set of two sheets a connecting flap projecting on one side with a first folding line taken as a boundary and a connected flap corresponding to the connecting flap being formed on a rear surface of the other side, a second folding line being formed between the connecting flap and the connected flap, a connecting-flap side sheet being provided between the first folding line and the second folding line, the connected-flap side sheet being provided between the second folding line and the connected flap, an assembly which comprises an upper-position control means and a lower-position control means provided at the respective positions at least scheduled to be folded in the one set of sheets for the corrugated cardboard box, an upper connecting-flap folding means for folding the connecting flaps of the both sheets for the corrugated cardboard box with the respective first and second folding lines taken as boundaries, and an upper connected-flap side sheet folding means for folding the connected-flap side sheet, and another assembly which comprises a lower connecting-flap folding means for folding the connecting flaps with the respective first and second folding lines taken as boundaries in the both sheets for the corrugated cardboard box and a lower connected-flap side sheet folding means for folding the connected-flap side sheets and is provided on a diagonal line and symmetric with respect to the assembly which comprises the upper connecting-flap folding means and the upper connected-flap side sheet folding means, an upper intermittent moving means for intermittently moving the both sheets for corrugated cardboard box, a lower intermittent moving means for intermittently moving the both sheets for the corrugated cardboard box and provided on a diagonal line and symmetric with respect to the upper intermittent moving means, an upper sewing machine which comprises a sewing-machine needle mechanism provided with a sewing-machine needle movable in the horizontal direction and a looper mechanism having a needle plate, and a lower sewing machine which comprises a sewing-machine needle mechanism provided with a needle movable in the horizontal direction and a looper mechanism having a needle plate and is provided on a diagonal line and symmetric with respect to the upper sewing machine.

The needle plates of the looper mechanisms are set inside the respective connecting flaps scheduled to be thread-stitched and the sewing-machine needle mechanisms are set outside the respective connected flaps scheduled to be thread-stitched.

While the sewing-machine needle is synchronized with the intermittent movement of the intermittent moving means to reciprocally move it from the outside of the connected flap to the inside connecting flap in the horizontal direction, the threading portion, which comprises the connecting flap and the connected flap, is stitched with threads.

According to a third means for solving the problem of the present invention, in the second solution:

the upper connected-flap side sheet folding means for folding the connected-flap side sheet and the upper position-control means disposed near the upper connected-flap side sheet folding means are provided so that they can vertically move respectively, and the upper transporting means is provided so as to be vertically movable and have its widthwise spacing adjustable;

the upper intermittent moving means, the upper sewing machine, the upper connecting-flap folding means for folding the connecting flap, and the upper position-control means disposed near the connecting-flap folding means are provided so as to be vertically and horizontally movable, respectively;

the lower connected-flap side sheet folding means for folding the connected-flap side sheet and the lower position-control means disposed near the lower connected-flap side sheet folding means are provided so that they can horizontally move, respectively; and

the lower transporting means is provided so as to be horizontally movable and have its lengthwise spacing adjustable.

The first solution to solve the problem of the present invention is constructed as above and therefore offers the following function and effect.

Particularly, one sheet for the corrugated cardboard box is arranged above in a horizontal state and the other sheet for the corrugated cardboard box is arranged below and symmetric with respect to one of the sheets for the corrugated cardboard box in the horizontal state and both of the above-mentioned sheets are maintained at their positions thus arranged;

the connecting flap of one of the sheets for the corrugated cardboard box is bent at right angles inwards downwardly with the first folding line taken as a boundary and the connected-flap side sheet of the other sheet for the corrugated cardboard box is bent at right angles inwards upwardly with the second folding line taken as a boundary to form the position of the both sheets of the corrugated cardboard box into a shape rectangular in section;

threading portions each of which comprises the connecting flap and the connected flap opposed to one another are set on a diagonal line and retain theirs positions as they are so set;

two sets of sewing machines each of which comprise a sewing-machine needle mechanism provided with a sewing-machine needle movable in a horizontal direction and a looper mechanism having a needle plate are arranged beside the threading portions, respectively;

the needle plate of the looper mechanism is set inside one of the threading portions and the sewing-machine needle mechanism is set outside the other; and

while the both sheets for the corrugated cardboard box, formed in the shape rectangular in section are intermittently moved in parallel to the first and second folding lines, the sewing-machine needle is synchronized with that intermittent movement to reciprocally move from the outside to the inside of the threading portions in the horizontal direction so as to stitch the threading portions.

In consequence, both of the sheets which have their positions controlled in preparation for the thread-stitching step and besides are bent through the folding lines are formed into a rectangular shape in section. Thus the threaded portions to be formed appear vertically in preparation for the thread-stitching step. This remedies the disadvantage caused by the fact that the sheet is burdened with load, thereby enabling us to expect the reliability of the thread-stitching.

According to the invention disclosed in each of Japanese Patent Appln. Laid-Open No. 2006-175157 and Japanese Registered Utility Model No. 3142579, the sheet for corrugated cardboard box on the side of the connected flap to be thread-stitched and the connecting flap are overlaid one on another in the horizontal direction. This has caused a likelihood that the load of the sheet is applied to the case which houses the needle plate and the looper to thereby bend or deform the needle plate and the case with the result of causing disorder in the relationship of position between the needle, the looper and the needle plate to reduce the reliability of the thread-stitching.

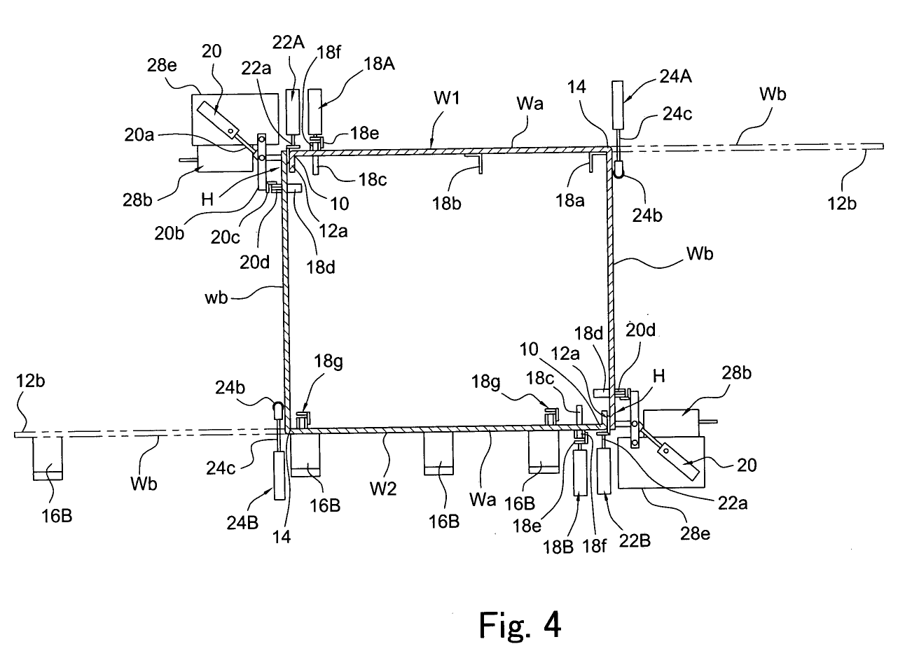

On the other hand, the present invention has the subject matter to bond the sheets, in one unit, for a heavy corrugated cardboard box which weights as much as 2050 g per sheet. Since the sheet for the corrugated cardboard box on the side of the connected flap and the connecting flap are restricted to such an extent that they are overlaid vertically one on another so as to hung down, their load is seldom applied to the looper mechanism side such as the case and the needle plate and therefore the reliability of the thread-stitching is expectable (see FIG. 4).

As a result, no bending nor deformation occurs on the looper mechanism side such as the case and the needle plate, so that the looper mechanism can be always maintained in order. This makes it possible to expect the reliability of the thread-stitching operation.

The second means for solving the problem of the present invention is constituted as above and therefore offers the following function and effect.

In addition to the function and effect common to that of the first solution, the upper position-control means and the lower position-control means are provided at the respective positions where they are scheduled to be folded. And the assembly which comprises the upper connecting-flap side sheet folding means for folding the connecting flap with the first and second folding lines in each of the both sheets for the corrugated cardboard box taken as boundaries and the upper connected-flap side sheet folding means for folding the connected-flap and another assembly which comprises the lower connecting-flap folding means and the lower connected-flap side sheet folding means are arranged on a diagonal line and symmetric with respect to each other. Therefore, it is possible to bond the connecting flap and the connected-flap side sheet along the respective folding lines into an L-shape in section and an inversed L-shape in section while controlling their positions without allowing the both sheets to make the blind-movement.

As a result, both of the sheets can be each formed rectangular in section in preparation for the thread-stitching and can be synchronized with the reciprocal movements of the sewing-machine needles by the upper intermittent moving means and the lower intermittent moving means so as to be stitched together with threads.

The third solution is constituted as above and therefore offers the following function and effect.

The upper transporting means, the upper connected-flap side sheet folding means for folding the connected-flap side sheet and the upper position-control means disposed near the upper connected-flap side sheet folding means are provided so that they can vertically move respectively, and the upper transporting means is arranged so as to have its widthwise spacing adjustable;

the upper intermittent moving means, the upper sewing machine, the upper connecting-flap folding means for folding the connecting flap, and the upper position-control means disposed near the connecting-flap folding means are provided so as to be vertically and horizontally movable, respectively;

the lower connected-flap side sheet folding means for folding the connected-flap side sheet, the lower position-control means disposed near the lower connected-flap side sheet folding means and the lower transporting means are provided so that they can horizontally move, respectively; and

the lower transporting means is provided so as to have its lengthwise spacing adjustable.

The above arrangement can provide a generally usable bonding method and apparatus which can attend in correspondence with every size of the sheet for the corrugated cardboard box either large or small as regards the bonding of the sheet for the corrugated cardboard box no matter how large it is.

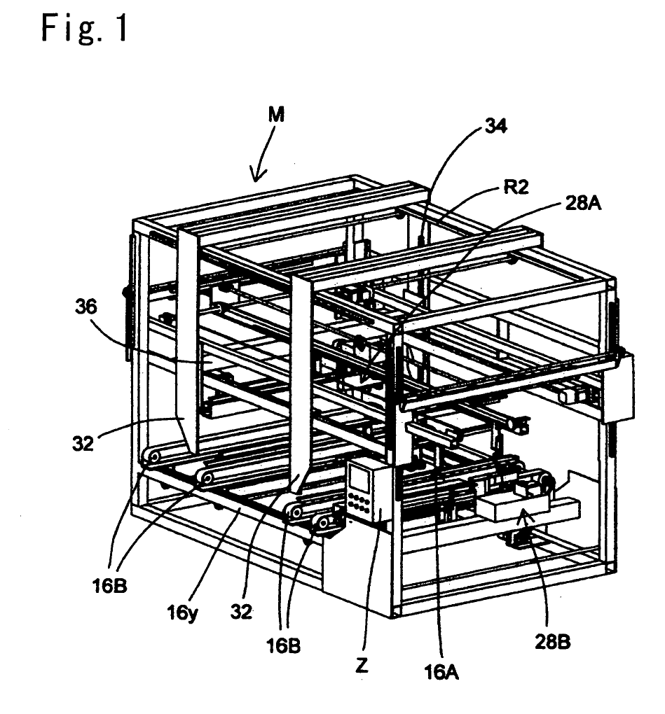

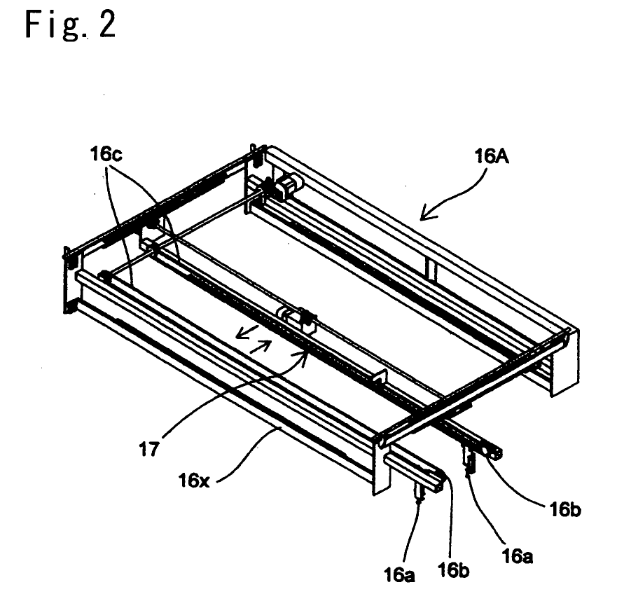

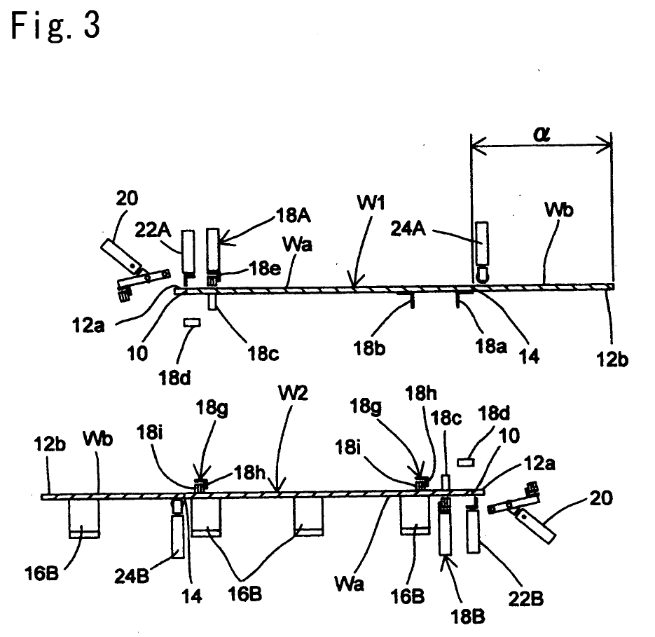

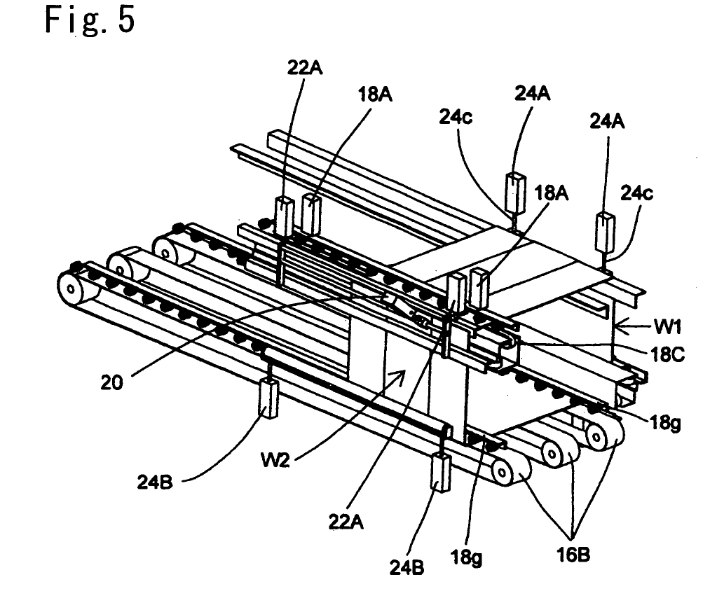

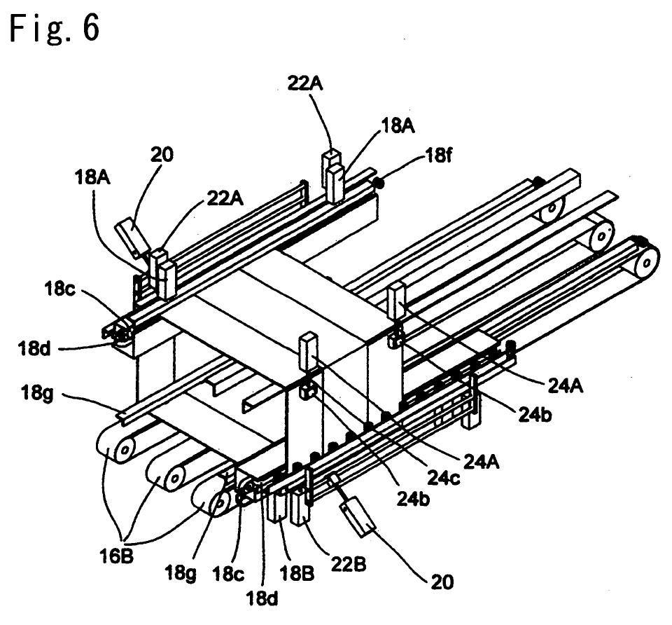

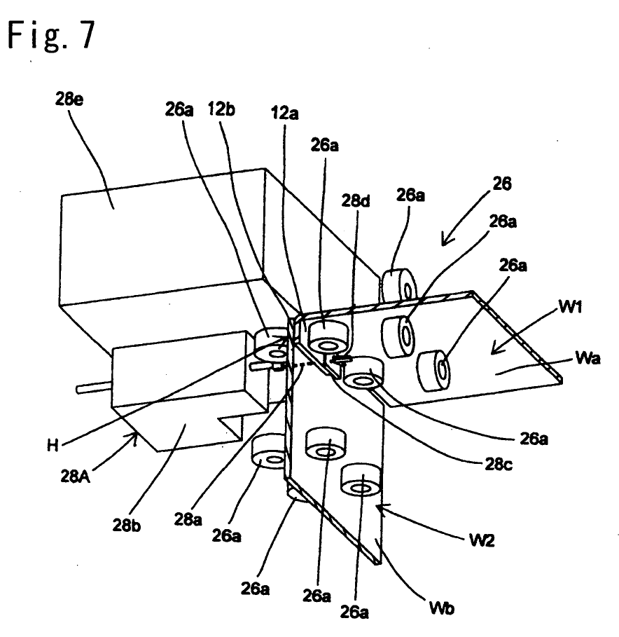

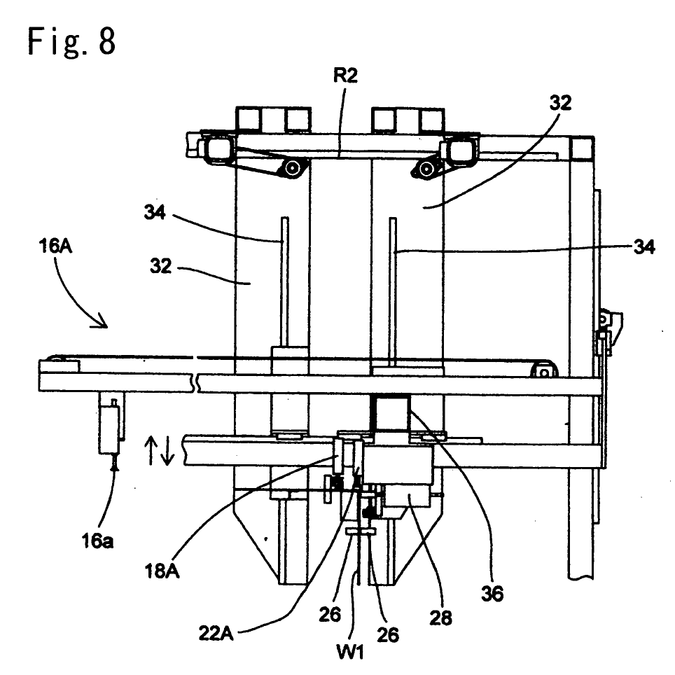

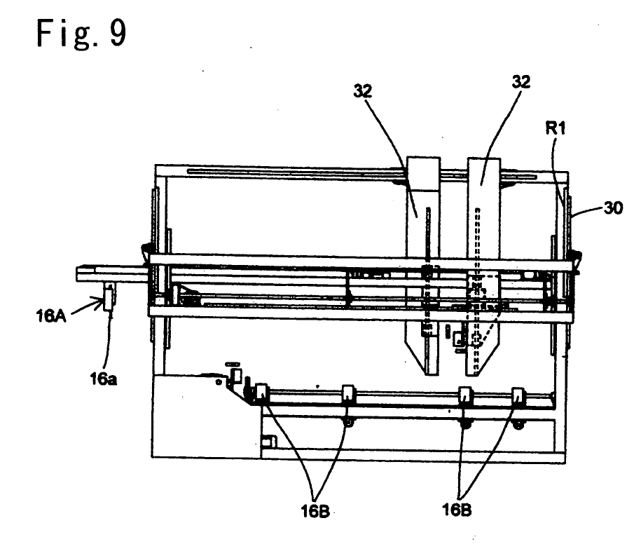

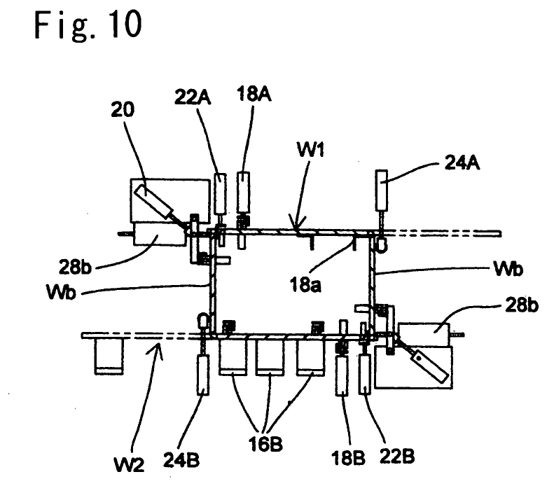

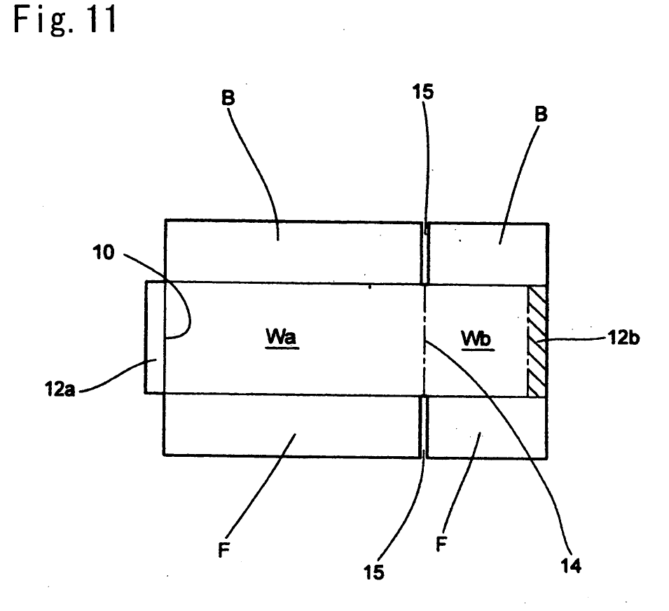

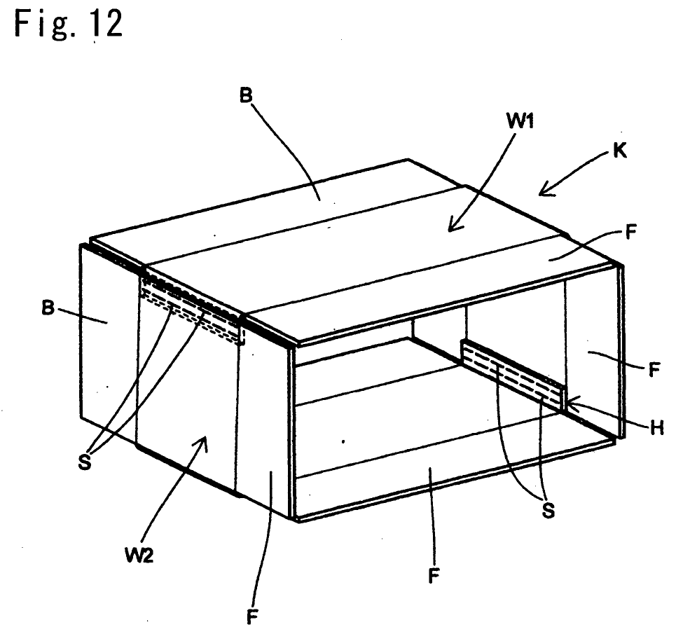

### BRIEF DESCRIPTION OF THE DRAWING

[FIG. 1] is a perspective view of an apparatus according to the present invention in its entirety;

[FIG. 2] is a perspective view of an upper transporting means of the apparatus;

[FIG. 3] shows a position-control means and a bending means of the apparatus before a folding operation;

[FIG. 4] shows the position-control means and the bending means of the apparatus after the folding operation;

[FIG. 5] is a perspective view of a left side showing an essential portion of the apparatus;

[FIG. 6] is a perspective view of a right side showing an essential portion of the apparatus;

[FIG. 7] is a perspective view showing how an upper intermittent moving means and an upper sewing machine stitch the sheets for corrugated cardboard box with threads;

[FIG. 8] is a sectional view showing an essential portion of the apparatus;

[FIG. 9] is a rear view showing an essential portion of the apparatus;

[FIG. 10] shows another embodiment of the apparatus;

[FIG. 11] is a plan view of a sheet for corrugated cardboard box;and

[FIG. 12] is a perspective view of a corrugated cardboard box.

### DETAILED DESCRIPTION OF THE PREFERRED EMBODIMENT

When bonding a threading portion which comprises a connecting flap of a sheet for a heavy, so-called two-piece type, corrugated cardboard box and a connected flap thereof by thread-stitching, the object to avoid the load burdened by the sheet for corrugated cardboard box is accomplished by setting the threading portion vertically and reciprocally moving a sewing-machine needle in a horizontal direction with respect to the threading portion.

The present invention is directed to a configuration formed by one set of two sheets W1 and W2 for a corrugated cardboard box K, i.e. a corrugated cardboard box of so-called “two-piece type” in the art.

For instance, as an example of a large-sized corrugated cardboard box, a sheet for the corrugated cardboard box, which is 2600 mm in length and 1200 mm in width and weights 2050 g, is included in schedule.

FIG. 12 shows flaps forming cover pieces F and bottom pieces B of a box K as well as slits 15, 15 but the cover pieces F, the bottom pieces B and the slits 15 may be present or absent.

The present invention is explained in details with reference to the drawings hereafter as well as a method invention and an apparatus invention.

According to the present invention, a connecting flap 12a projects on one side with a first folding line 10 taken as a boundary and a portion 12b to be connected (hereafter referred to only as ‘connected flap’) corresponding to the connecting flap 12a is formed on a rear surface of the other side. A second folding line 14 is formed between the connecting flap 12a and the connected flap 12b. One set of two sheets W1 and W2 for a corrugated cardboard box is provided with a connecting-flap side sheet Wa between the first folding line 10 and the second folding line 14 as well as with a connected-flap side sheet Wb between the second folding line 14 and the connected flap 12b. The connecting flap 12a and the connected flap 12b of each of the two sheets W1 and W2 constitute a threading portion H. Thus the present invention concerns a method for bonding the threading portion H with stitching threads S and an apparatus M therefor (see FIGS. 11 and 12).

### [Upper Transporting Means]

When an upper transporting means 16A is explained with reference to FIGS. 1 and 2, it is intended for transporting one of the sheets W1, positioned-up, for the corrugated cardboard box to above the apparatus M in preparation for the next folding step and its concrete example mainly consists of a so-called adsorbing pad 16a, although not shown in details.

A plurality of adsorbing pads 16a are connected to ejectors and are each governed by a reciprocal movement of a piston housed in a cylinder. The adsorbing pads 16a descend on the sheet W1 preliminarily placed on a support in a horizontal state and are brought into contact with the sheet W1 to adsorb it by a sucking action.

In consequence, the adsorbing pads 16a adsorbing the sheet W1 reciprocally move to thereby transport the sheet W1 to the next step while holding it in the horizontal state and then can descend to a predetermined position.

The adsorbing pads 16a are vertically suspended from chains 16c wound around opposite rotatable sprocket wheels 16b and are governed by the reciprocal movements of the chains 16c.

Further, in this embodiment, the both sheets W1 and W2 are folded by a folding means to be mentioned later, into a rectangular shape in section and are sent to a thread-stitching step. But the vacant main portion 17 of the upper transporting means 16A is returned to an initial position and waits in preparation for the transportation of the next sheet W1.

As for the upper transporting means 16A, there is listed an example adopting the adsorbing pads 16a as a main element in an attempt to inhibit principally the increase of a space for the apparatus M. But there is no intention for limiting it to this example.

For instance, the inventors are considering to adopt a belt conveyor like a concrete example of a lower transporting means 16B to be explained later.

Although explained later in details, the upper transporting means 16A placed on the support 16x is associated with one W1, which is transported to above the apparatus M, of the sheets W1 and W2 for the corrugated cardboard box either large or small. And it is vertically movable and besides has the plurality of adsorbing pads 16a mutual widthwise spacing of which is adjustable so that it can attend to the transportation no matter how large the corrugated cardboard box is.

### [Lower Transporting Means]

The lower transporting means 16B is intended for the other sheet W2, positioned-down, of the sheets for the corrugated cardboard box to below the apparatus M in preparation for the next folding step. Although detailed illustration is omitted, a well known belt conveyor is adopted for a concrete example and especially a four-line belt conveyor is employed so that it can also attend to the transportation of a long sheet W2 (see FIGS. 1, 3 and 4).

One of the sheets W1 for the corrugated cardboard box and the other W2 are preliminarily arranged symmetric with respect to each other and fed to the upper transporting means 16A and the lower transporting means 16B, and transported by them, respectively so as to fold one set of the two sheets W1 and W2 into a rectangular shape in section in preparation for the thread-stitching step.

It is to be noted for reference that on the drawings, a connecting flap 12a of one of the sheets W1 for the corrugated cardboard box is positioned to the left and another connecting flap 12a of the other sheet W2 for the corrugated cardboard box is situated to the right (see FIGS. 3 and 4).

Further, as shown in FIG. 3, when the connected-flap side sheet Wb of one of the sheets W1 is bent downwardly at right angles and the connected-flap side sheet Wb of the other sheet W2 is bent upwardly at right angles by displacing and arranging the former rightward on the drawing with respect to the latter by a distance equal to a length a of the connected flap side sheet Wb of one of the sheets W1 for the corrugated cardboard box through an upper connected-flap side sheet folding means 24A and a lower connected-flap side sheet folding means 24B to be explained later, the respective connected flaps 12b, 12b can be disposed opposite to outside the connecting flaps 12a, 12a as they are. This makes it possible to easily obtain a threading portion H for the thread-stitching.

Although the belt conveyor is listed as an example of the lower transporting means 16B, there is no intention for limiting it to this example.

For example, like the concrete example of the previously explained upper transporting means 16A, the inventors are prepared to adopt a transporting means which mainly consists of an adsorbing pad 16a.

Although explained later in details, the lower transporting means 16B placed on a support 16y is associated with the other W2, which is transported to below the apparatus, of the sheets W1 and W2 for the corrugated cardboard box either large or small. The four-line belt conveyor has its mutual spacing adjustable so that it can attend to the transportation no matter how large the sheet for the corrugated cardboard box is.

Additionally, the four-line belt conveyor stops the lower transporting means 16B, thereby enabling the rear surface side of the other sheet W2 for the corrugated cardboard box to be position-controlled. Thus this belt conveyor serves as the lower transporting means 16B and at the same time constitutes part of the lower position-controlling means to be explained later.

### [Upper Position-Controlling Means]

This upper position controlling means is intended for controlling the position of one W1 of the two sheets W1 and W2 in one set for the corrugated cardboard box to be transported to above the apparatus M in preparation for the next folding step.

Apparently from FIG. 3 or FIG. 6, the upper position-controlling means attempts to control the horizontal position of the one sheet W1 when folding it as well as the L-shaped position and inversed L-shaped position in section of the folded one sheet W1, respectively.

Especially a mechanism for controlling the positions of the threading portions in the both sheets W1 and W2 rectangular in section is devised.

A concrete example of the upper position control means, as shown in FIG. 3 or FIG. 6, is provided with members for supporting a rear surface and an outer surface of the sheet W1, respectively.

These members are preferably arranged near inside the first folding line 10 of one of the sheets W1 for the corrugated cardboard box scheduled to be folded and close to inside the second folding line 14 thereof, respectively.

The members for supporting the rear surface of the sheet W1 are disposed near inside the first folding line 10 and close to inside the second folding line 14, respectively. This makes it easy to fold the connecting flap 12a of one of the sheets W1 for corrugated cardboard box with the folding line 10 taken as a boundary and the connected-flap side sheet Wb with the second folding line taken as a boundary.

With reference to FIG. 3, a first elongated angle member 18a, inversed L-shaped in section, is provided near inside the second folding line 14.

Further, the angle member 18a is provided vertically movable, although it is explained later in details.

On the other hand, although explained later in details, a second elongated, inversed L-shaped in section, angle member 18b is provided inside the first elongated angle member 18a, inversed L-shaped in section, horizontally and vertically movable in attempt to effect a secondary function other than the position-controlling of the sheet W1.

A first corner belt conveyor 18c is provided for supporting the rear surface of the sheet W1 near the first folding line 10.

This belt conveyor 18c is a multi-purpose one differently from the above-mentioned lower transporting means 16B.

A first one of the purposes is to support the rear surface of the sheet W1 near the first folding line 10 and a second one is to transport the both sheets W1 and W2 shaped rectangular in section after folding in preparation for the thread-stitching step.

The first corner belt conveyor 18c stops in attempt to support the rear surface of the sheet W1 by utilizing its upper surface as do the first elongated, inversed L-shaped in section, angle member 18a and the second elongated, inversed L-shaped in section, angle member 18b.

Moreover, with reference to FIGS. 3 and 4, a second corner belt conveyor 18d is additionally provided in the vicinity of the first corner belt conveyor 18c.

The second corner belt conveyor 18d contributes to the transportation in preparation for the step of thread-stitching the both sheets rectangular in section after the folding step and besides controls the folded other connected-flap side sheet Wb of the other sheet so as not to perform a blind-movement, together with a blind-movement inhibiting member 20.

Apparently with reference to FIG. 4, when transporting both of the two sheets W1 and W2 rectangular in section toward the thread-stitching step, even if only the lower transporting means 16B of four-line belt conveyor tries to carry them out, it can merely support their rear surfaces and encounters difficulty in transporting them while retaining their position rectangular in section. In the light of this difficulty, the first corner belt conveyor 18c and the second corner belt conveyor 18d are provided particularly at the respective positions of the both sheets W1 and W2 scheduled to be folded.

The present invention has an object to transport both of the heavy sheets W1 and W2 as mentioned above. Therefore, as a matter of course, the four-line belt conveyor contributes to the transport.

The second corner belt conveyor 18d is brought into butting contact with the inside of the connected-flap side sheet Wb of the other sheet W2 rectangular in section after the folding step and contributes to controlling its position and transporting it.

The pivotable blind-movement inhibiting member 20 is provided outside the second corner belt conveyor 18d.

The blind-movement inhibiting member 20 to be explained later in details is brought into butting contact with the outside of the connected-flap side sheet Wb to thereby inhibit the connected-flap side sheet Wb from making the blind-movement, together with the second corner belt conveyor 18d.

The sheet W1 can be controlled so as to retain its horizontal position by the upper position-control means which comprises the first elongated, inversed L-shaped in section, angle member 18a, the second elongated, inversed L-shaped in section, angle member 18b and the first corner belt conveyor 18c.

On the other hand, as mentioned above, regarding the position-control of both of the two sheets W1 and W2 rectangular in section, this embodiment intends to perform the position-control of one of the sheets W1 for the corrugated cardboard box from its outer surface as well. Thus an explanation is made on this point.

Apparently with reference to FIG. 3 or FIG. 6, the outer-surface position-control means 18A is vertically movable.

An elongated angle member 18e reversed L-shaped in section is provided above the first corner belt conveyor 18c. A number of rollers 18f are vertically and rotatably loaded through a spring inside the elongated angle member 18e to which a piston vertically movable within the cylinder is connected.

The outer-surface position-control means 18A has its piston descended to bring the rollers 18f into butting contact with the outer surface of the sheet W1 so as to control the outer surface side of the sheet W1 and can control the rear surface of the sheet W1 with the first corner belt conveyor 18c while holding it therebetween. Therefore, it is expectable to control the position of the sheet W1 with more assuredness.

Then an explanation is made on the blind-movement inhibiting member 20 mentioned above.

The blind-movement inhibiting member 20 is a member common to the lower position-control means and is provided on a diagonal line and symmetric with respect to the upper blind-movement inhibiting member 20.

This blind-movement inhibiting member 20 is supported by the outside surface of the folded connected-flap side sheet Wb above the other one W2 of the two sheets W1 and W2 in one set for the corrugated cardboard box transported to below the apparatus M to control the position of the other sheet W2 on transporting it to the thread-stitching step, together with the second corner belt conveyor 18d.

The present invention, as mentioned above, folds the large-sized sheets W1 and W2 into rectangular shape in section and thread-stitch them together. Accordingly, the connected-flap side sheet Wb after it has been folded is made upright vertically.

When making the sheet Wb upright, the piston 24c of the lower connected-flap side sheet folding means 24B ascends to bring the roller 24b attached to the piston 24c into butting contact with the outside surface of the sheet Wb and hold it so as to be able to control its position. However, as regards the large-sized connected-flap side sheet Wb, the blind-movement is liable to occur especially when controlling its upper side position.

Therefore, in order to solve the above problem, the blind-movement inhibiting member 20 is provided above the lower connected-flap side sheet folding means 24B and opposite to the second corner belt conveyor 18d.

Concretely speaking, the blind-movement inhibiting member 20 comprises a cylinder and piston 20a, a pivotal member 20b attached around a support axis swingably, and an elongated roller member 20c rectangular in section, connected to the pivotal member 20b. A number of rollers 20d are attached to the roller member 20c rotatably through a spring.

The blind-movement inhibiting member 20 is pivotal. Therefore, the pivotal member 20b is pivoted toward the sheet Wb on transporting it to the thread-stitching step and the rotating roller 20d contacts with the outside of the sheet Wb, thereby controlling the position of the sheet Wb and transporting the sheet Wb to the thread-stitching step, together with the driven second corner belt conveyor 18d.

On the other hand, after the sheet Wb has been transported to the thread-stitching step, the blind-movement inhibiting member 20 is pivoted toward the initial position in preparation for the thread-stitching operation and then the position-control and the transportation are canceled.

### [Lower Position-Control Means]

The lower position-control means is intended for controlling the position of the other sheet W2 of the two sheets W1 and W2 in one set for the corrugated cardboard box to be transported to below the apparatus M in preparation for the next folding step.

This lower position-control means attempts, apparently from FIGS. 3 or FIG. 6, to control the horizontal position of the other sheet W2 when folding it and its respective L-shaped and inversed L-shaped positions in section, after it has been folded.

The lower position-control means comprises members for controlling the outer surface side and the rear surface side of the sheet W2, although not shown in details. Among them, the four-line belt conveyor stops to support the rear surface of the sheet W2.

Further, the outer-surface position-control means 18A adopted as the upper position-control means in attempt to control the position of the sheet W2 from its rear surface side is employed for the rear-surface position control means 18B as it is and is provided diagonally and symmetrically.

Additionally, the first belt conveyor 18c, the second corner belt conveyor 18d and the pivotal blind-movement inhibiting member 20 adopted for the upper position-control means are utilized as they are and is provided diagonally and symmetrically in attempt to improve the position-control of the other sheet W2. However, its function is common to that exerted by the upper position-control means.

Although only the lower position-control means of four-line belt conveyor is basically able to control the position of the sheet W2, this embodiment also intends to control the position of the other sheet W2 for the corrugated cardboard box from its outer surface side. Thus an explanation is made on this point.

Apparently with reference to FIGS. 3 or FIG. 6, secondary outer-surface side control-position means 18g are provided on the belt conveyors near the opposite sides.

The secondary outer-surface position-control means 18g comprises an elongated angle member 18h, inversed L-shaped in section, and a number of rollers 18i. The rollers 18i are vertically and rotatably attached and governed through an urging action of a spring not shown. It controls the position of the other sheet W2 transported onto the belt conveyor from its outer surface as well to control its position while holding it between the outer surface and the rear surface, together with the belt conveyor in attempt to ensure the position-control.

Next, an explanation is given for an upper connecting-flap folding means 22A and an upper connected-flap side sheet folding means 22B for folding the connecting flap 12a and the connected-flap side sheet Wb through the respective first and second folding lines 10 and 14 of the both sheets W1 and W2 for the corrugated cardboard box.

### [Upper Connecting-Flap Folding Means]

The upper connecting-flap folding means 22A arranges the both sheets W1 and W2 for the corrugated cardboard box at vertically symmetric positions with respect to the apparatus M in preparation for the next thread-stitching step.

While the upwardly positioned one sheet W1 for the corrugated cardboard box has the connecting flap 12a intended to be folded at right angles downwardly, the downwardly positioned other sheet W2 for the corrugated cardboard box has the connecting-flap 12a intended to be folded at right angles upwardly. Thus there is such a difference between them. Further, although they differ from each other in that they are provided diagonally and symmetrically with respect to each other, they are common in construction and function.

Although not shown in details, a concrete example comprises a piston and cylinder 22a. As for one connecting flap 12a, a vertically movable piston is arranged toward the connecting flap 12a scheduled to be folded above a portion near its first folding line 10 (see FIG. 3 or FIG. 6) and is lowered so that the connecting flap 12a can be folded at right angles downwardly with the first folding line 10 taken as a boundary.

As to the other connecting flap 12a, a vertically movable piston 22a is arranged toward the other connecting flap 12a below the one connecting flap 12a symmetric with respect to the latter and is raised so that the other connecting flap 12a can be folded at right angles upwardly with the first folding line 10 taken as a boundary (see FIG. 3 or FIG. 6).

### [Upper Connected-Flap Side Sheet Folding Means]

The upper connected-flap side sheet folding means 24A arranges the both sheets W1 and W2 for the corrugated cardboard box at vertically symmetric positions with respect to the apparatus M in preparation for the next thread-stitching step (see FIG. 3 or FIG. 6)

While the upwardly positioned one sheet W1 for the corrugated cardboard box has the connected-flap side sheet Wb intended to be folded at right angles downwardly, the downwardly positioned other sheet W2 for the corrugated cardboard box has a connected-flap side sheet Wb intended to be folded at right angles upwardly. Thus there is such a difference between them. But they are common in construction and function.

Although not shown in details, a concrete example comprises a cylinder and a piston 24c having a leading end to which a roller 24b is attached rotatably. Two ones are provided at a predetermined spacing so that they can fold the sheet Wb from both sides (see FIG. 3 or FIG. 6).

As regards one sheet W1, the vertically movable piston 24a is lowered onto the upper connected-flap side sheet Wb of the sheet W1 to fold the connected-flap side sheet Wb with the second folding line 14 taken as a boundary at right angles downwardly (see FIG. 3 or FIG. 4).

### [Lower Connecting-Flap Folding Means]

The lower connecting-flap folding means 22B arranges the both sheets W1 and W2 for the corrugated cardboard box at vertically symmetric positions of the apparatus M in preparation for the next thread-stitching step.

It is common to the above-mentioned upper connecting-flap folding means 22A in construction and function. Therefore, its explanation is also available here.

### [Lower Connected-Flap Side Sheet Folding Means]

As to the other sheet W2, a vertically movable piston 24c is arranged toward the connected-flap side sheet Wb below the sheet W2 symmetric with respect to the previously mentioned one connected-flap side sheet folding means 24A and is raised in a direction opposite to the direction for folding the connected-flap side sheet Wb of the previously explained one of the sheets W1 for the corrugated cardboard box so that the connected-flap side sheet Wb can be folded at right angles upwardly with the second folding line 14 taken as a boundary.

The roller 24b for each of the upper connected-flap side sheet folding means 24A and the lower connected-flap side sheet folding means 24B acts to aid in effecting the position-control from the outer side of the connected-flap side sheet Wb remaining rectangular in section after it has been folded.

By folding the respective connecting flaps 12a of the both sheets W1 and W2 prior to folding the respective connected-flap side sheets Wb thereof, the respective connected-flaps 12b are opposed to outside the respective connecting-flaps 12a to form threading portions H, respectively on a diagonal line.

### [Upper Intermittent Moving Means]

The upper intermittent moving means 26 intermittently moves the both sheets W1 and W2 in a synchronized manner with a reciprocal movement of a sewing-machine needle 28a on thread-stitching the threading portions of the both sheets W1 and W2 each folded into a rectangular shape in section in the previous step.

Since the intermittent moving means 26 are provided beside the sewing machine 28 but diagonally and symmetrically, an explanation is made only for the upper intermittent moving means 26. As regards the lower intermittent moving means 26, the explanation is also applicable thereto and it is not shown.

Apparently with reference to FIG. 7, the both sheets W1 and W2 scheduled to be folded are formed into L-shape and inversed L-shape in section respectively as mentioned above.

The both sheets W1 and W2, each of which consists of two pieces as such, are arranged to intermittently move without making the blind-movement, in preparation for the thread-stitching.

The connecting-flap side sheet Wa including the vertical connecting-flap 12a of one of the sheets W1 and the connecting-flap side sheet Wb including the vertical connected-flap 12b of the other sheet W2 constitute a threading portion H. Two rollers 26a are provided on one side of the threading portion H as well as on the other side thereof to hold the threading portion H therebetween while they are rotating.

The two horizontally rotatable rollers 26a on one side are spaced from the two horizontally rotatable rollers 26a on the other side at an interval so set as not to interfere with the horizontally moving sewing-machine needle 28a.

Further arrangement is made in attempt to ensure the position and the intermittent movement while the both sheets W1 and W2 are intermittently moving.

One pair of two rollers 26a are spaced from another pair of two rollers 26a at a predetermined interval vertically and rotatably on a upper side of the connecting-flap side sheet Wa of one of the sheets W1 scheduled to be intermittently moved as well as on a lower side thereof.

One pair of two rollers 26a are spaced from another pair of two rollers 26a at a predetermined interval horizontally and rotatably on the opposite sides of the connected-flap side sheet Wb of the other sheet W2 scheduled to be intermittently moved.

Although all of the 12 rollers 26a in total are not shown, these 12 rollers 26a are connected to a servo motor not shown in attempt to synchronize the movement of the both sheets W1 and W2 with the reciprocal movement of the sewing-machine needle 28a and move them in good order.

### [Lower Intermittent Moving Means]

The lower intermittent moving means, as mentioned above, intermittently moves the both sheets W1 and W2 while synchronizing their intermittent movement with the reciprocal movement of the sewing-machine needle 28a when thread-stitching the threading portion H below the both sheets W1 and W2 each folded into a rectangular shape in section.

The lower intermittent moving means is different from the upper intermittent moving means 26 in that it is provided diagonally and symmetrically but is common thereto in construction and function. Therefore, the explanation for the upper intermittent moving means 26 is used here and is not shown.

### [Upper Sewing Machine]

An upper sewing machine 28A comprises a sewing-machine needle mechanism 28b provided with the sewing-machine needle 28a horizontally movable and a looper mechanism 28d having a needle plate 28c.

The upper sewing machine 28A is provided beside the respective connecting flap 12a and connected flap 12b scheduled to be thread-stitched.

The needle plate 28c of the looper mechanism 28d is provided inside each of the connecting flaps 12a scheduled to be thread-stitched.

On the other hand, the needle mechanism 28b is provided outside each of the connected flaps 12a.

And the sewing-machine needle 26a is synchronized with the intermittent movement of the upper intermittent moving means 26 to be horizontally and reciprocally moved from the outside to the inside of the connected-flap 12b, thereby enabling the threading portion H which consist of the connecting flap 12a and the connected flap 12b to be stitched with threads S.

Numeral ‘28e’ in FIG. 7 indicates a case housing various sorts of control members for controlling the sewing-machine needle mechanism 28b.

It is to be noted that this embodiment adopts two needles to stitch the threading portion H with two lines at the same time. This can inhibit the disadvantage caused if the first folding line 12a is damaged.

For example, even if the first folding line 12a is damaged to cause a fear that the function of the threads S on the side of the damaged folding line 12a is not expectable, the threads S other than those on the damaged folding line 12a side can compensate the disadvantage caused by the folding line 12a.

As for the threads S, natural textile fibers such as staple fibers are preferably adopted with the view to avoid the environmental disruption in the case where an attention is paid to the final procedure, namely disposal procedure, after the corrugated cardboard box K stitched with the threads S has been used.

### [Lower Sewing Machine]

The lower sewing machine 28B is different from the upper sewing machine 28A in that it is provided diagonally and symmetrically but is common thereto in construction and function. Therefore, the explanation for the upper sewing machine 28A is available here and is not shown.

The above-mentioned upper transporting means, lower transporting means, outer-surface position-control means, upper position-control means, lower position-control means, upper connecting-flap folding means, upper connected-flap folding means, lower connecting-flap folding means, lower connected-flap side sheet folding means, upper intermittent moving means, lower intermittent moving means, upper sewing machine and lower sewing machine are controlled by operating the respective switches of the operation plate Z on a control panel (not shown) electrically connected thereto.

Hereafter, an explanation is given to the operation by the apparatus M.

One of the sheets W1 for the corrugated cardboard box is oriented on the drawings with the connecting flap 12a positioned on the left side and the adsorbing pad 16 of the upper transporting means 16A adsorbs the connecting flap 12a in a horizontal state and transports it to a predetermined position within the apparatus M for the next step.

The transported sheet W1 has the position of its rear surface controlled by the first corner belt conveyor 18c in ceased state, the first elongated, inversed L-shaped in section, angle member 18a and the second elongated, inversed L-shaped in section, angle member 18b.

The other sheet W2 for the corrugated cardboard box is oriented on the drawing with its connected-flap side sheet Wb positioned on the left side symmetric with respect to one of the sheets W1 therebelow and is transported by the belt conveyor of the lower transporting means 16B to a predetermined position within the apparatus M in a horizontal state. But it is held between the belt conveyors and the opposite secondary outer-surface position-control means 18g against the urging force exerted by the position-control means 18g.

In this case, as shown in FIGS. 3 and 4, on the drawing, one of the sheets W1 for the corrugated cardboard box is displaced to the right with respect to the other sheet W2 by a length (a) of the connected-flap side sheet Wb.

(4) In preparation for the bending step, the outer-surface position-control means 18A has its piston lowered toward the outer surface near the connecting flap 12a of one of the sheets W1 for the corrugated cardboard box. Then the roller 18f is brought into butting contact with the outer surface of the sheet W1 to control it and the rear surface of the sheet W1 with the first corner belt conveyor 18c while holding it therebetween.

(5) In preparation for the bending step, the rear-surface position-control means 18B has its piston raised toward the rear surface near the connecting flap 12a of the other sheet W2 for the corrugated cardboard box. Then the roller 18f is brought into butting contact with the rear surface of the sheet W2 to control it with the first corner belt conveyor 18c while holding it therebetween.

(6) The upper connecting-flap folding means 22A has its piston 22a lowered to fold the connecting flap 12a of one of the sheets W1 for the corrugated cardboard box downwardly at right angles with the first folding line 10 taken as a boundary.

(7) The lower connecting-flap folding means 22B has its piston 22a raised to fold the connecting flap 12a of the other sheet W2 for the corrugated cardboard box upwardly at right angles with the first folding line 10 taken as a boundary.

(8) The upper connected-flap side sheet folding means 24A has its piston 24c lowered to fold the connected-flap side sheet Wb of one of the sheets W1 for the corrugated cardboard box downwardly at right angles with the second folding line 14 taken as a boundary, so as to dispose the connected flap 12b opposite to the connecting flap 12a of the other sheet W2.

(9) The lower connected-flap side sheet folding means 24B has its piston 24c raised to fold the connected-flap side sheet Wb of the other sheet W1 for the corrugated cardboard box upwardly at right angles with the second folding line 14 taken as a boundary, so as to dispose the connected-flap 12b opposite to the connecting flap 12a of one of the sheets W1.

(10) The upper blind-movement inhibiting means 20 is pivoted toward below the connected-flap side sheet Wb of one of the sheets W1 for the corrugated cardboard box to bring the roller 20d into butting contact with the outer side of the sheet Wb and at the same time control its inner side by the second corner belt conveyor 18d and on the other hand, the lower blind-movement inhibiting means 20 is pivoted toward above the connected-flap side sheet Wb of the other sheet W2 for the corrugated cardboard box to bring the roller 20d into butting contact with the outer side of the sheet Wb and at the same time control its inner side by the second corner belt conveyor 18d, whereby both of the sheets W1 and W2 are controlled in a position rectangular in section and besides are transported to the thread-stitching step by the lower transporting means 16B, the first corner belt conveyor 18c and the second corner belt conveyor 18d.

At this transportation time, the outer one of the both sheets Wb is guided to move up and down by the roller 24b of the upper connected-flap side sheet folding means 24A.

(11) The both sheets W1 and W2, rectangular in section, transported to the thread-stitching step have their positions cancelled to become free. But their positions are controlled in compliance with the thread-stitching step of the next step by the upper intermittent moving means and the lower intermittent moving means and are stitched together with threads.

The thread-stitching is to thread-stitch the threading portion H by intermittently moving the both sheets W1 and W2 for the corrugated cardboard box, formed rectangular in section, in parallel to the first folding line 10 and the second folding line 14 and synchronizing the sewing-machine needle 28a with the intermittent movement and reciprocally moving it from the outside to the inside of the threading portion H in a horizontal direction.

Next, reference is made to the theme of another embodiment of the present invention which is to bond the corrugated cardboard box either large or small.

It relates to a method and an apparatus generally usable for bonding purpose, which can attend in correspondence with every size of the sheet for the corrugated cardboard box either large or small in the group of large-sized corrugated cardboard boxes.

No matter how large the sheets W1 and W2 for the corrugated cardboard box are, another embodiment is common to the previous embodiment in that all of the above-mentioned steps and every means of the apparatus M are essential.

On the other hand, in order to attend to the corrugated cardboard box either large or small no matter how large it is, every means of the apparatus is partly arranged movable horizontally and vertically. Further, the upper transporting means is provided vertically. Besides, a plurality of adsorbing pads 16a are spaced from one another at an adjustable interval. Thus reference is made to this fact as below.

This embodiment is essentially common to the previous invention. As for the common matters, the explanation and illustration therefor are also used here and accordingly are omitted. Then it is explained with reference to FIGS. 8 and 9 hereafter.

As to one of the sheets W1, either large or small, scheduled to be thread-stitched and arranged above, the upper transporting means 16A is vertically movable in attempt to make the transportation position of the sheet W1, large or small, correspond to a vertical appropriate position. In order to properly set the vertical position of each of the connected-flap 12b and the second folding line 14, the upper connected-flap side sheet folding means 24A is vertically movable as well as the first elongated, inversed L-shaped in section, angle member 18a near the folding means 24A.

The upper transporting means 16A is intended not only to be movable vertically but also to have a plurality of adsorbing pads 16a provided movable in correspondence with a direction between both sides, i.e. widthwise direction of the sheet W1 so as to be able to attend to the widthwise size, either large or small, of one of the sheets W1.

Further, the upper transporting means 16A has a length set to the length that is determined by taking into consideration the expectable largest one of one of the sheets W1 of this kind. Thus reference is not made to the lengthwise movement.

As for the connecting flap 12a side of one of the sheets W1, with reference to FIGS. 3 and 4, from the left to the right, the blind-movement inhibiting means 20, the upper connecting-flap folding means 22A, the outer-surface position-control means 18A, the first corner belt conveyor 18c, and the second corner belt conveyor 18d, the second elongated, inversed L-shaped in section, angle member 18b are attempted to be movable horizontally and vertically in correspondence with the length, either large or small, of the sheet W1.

As to the other sheet W2, either large or small, scheduled to be thread-stitched and arranged below, on the side of the connecting-flap sheet Wa of the other sheet W2, the first corner belt conveyor 18c near the connecting flap 12a, the second corner belt conveyor 18d, the rear-surface position-control means 18B, the lower connecting-flap folding means 22B and the blind-movement inhibiting member 20 are fixed, respectively.

As for the connected-flap side sheet Wb of the other sheet W2, from the left to the right on the drawing, the four-line belt conveyor 16B is provided so that the spacing between adjacent two lines of the four lines is adjustable in correspondence with the length, either large or small, of the other sheet W2.

Further, the lower connected-flap side sheet folding means 24B is provided movable horizontally as well as the secondary outer-surface position-control means 18g near the folding means 24B.

Further, the lower transporting means 16B has a width set to the width that is determined by taking into consideration the expectable largest one of the other sheet W2 of this kind. Thus reference is not made to the widthwise movement.

Although the upper transporting means 16A is explained to be vertically movable, a concrete example is controlled by a pinion engaged with the opposite vertical rack plates R1 and provided vertically movable through the opposite vertical guide rails 30.

Besides, the upper connected-flap side sheet folding means 24A is provided vertically movable through a vertically movable member as well as the first elongated, inversed L-shaped in section, angle member 18a near the folding means 22A. Additionally, in the case where a plurality of folding means 24A are provided, the spacing between them is adjustable.

It is explained that the blind-movement inhibiting member 20, the connecting-flap folding means 22A, the outer-surface position-control means 18e, the belt conveyor 18c, another belt conveyor 18d, the second elongated, inversed L-shaped in section, angle member 18b set to the side of the connecting-flap 12a of one of the sheets W1 are arranged in attempt to be movable horizontally and vertically so as to attend in correspondence with the length, large or small, of the sheet W1.

Then an explanation is given for a concrete example. This concrete example comprises a pair of frames spaced from each other at a constant interval in suspension.

These frames 32 are controlled by a pinion engaged with the horizontal racks R2 through a connection member and are arranged to have their mutual spacing adjustable by the rotating action of the pinion.

A guide rail 34 is fixed to one of the frames 32 so that the blind-movement inhibiting member 20 and the second elongated, inversed L-shaped in section, angle member 18b can be comprehensively moved.

As a result, the blind-movement inhibiting member 20 and the like ones can be horizontally moved all together.

On the other hand, as regards the vertical movement, the connection member is guided by the guide rail 34 suspended from the frames 32 and controlled by the pinion engaged with the rack plates provided on both sides to move vertically.

Hereafter, an explanation is given to the operation of the apparatus M according to another embodiment (see FIG. 10).

The another embodiment is substantially not distinct from the previous embodiment in operation.

What is different resides in that the upper transporting means 16A, the upper connected-flap side sheet folding means 24A for folding the connected-flap side sheet Wb and the upper position-control means near the connected-flap side sheet folding means are vertically moved in correspondence with every size of the sheets W1 and W2, either large or small, and in that the upper transporting means 16A has its widthwise spacing adjustable.

On the other hand, the upper intermittent moving means 26, the upper sewing machine 28, the upper connecting-flap folding means 22A for folding the connecting flap, and the upper position-control means near the connecting-flap folding means are vertically and horizontally movable in correspondence with every size of the sheets W1 and W2, either large or small, respectively.

The thread-stitching is performed by horizontally moving the lower connected-flap side sheet folding means 24B for folding the connected-flap side sheet, the lower position-control means 16B near the lower connected-flap side sheet folding means and the lower transporting means 16B and adjusting the lengthwise spacing of the lower transporting means 16B in correspondence with every size of the sheets W1 and W2, either large or small.

Apparently if compared with FIG. 4, it could be understood that FIG. 10 shows how the above-mentioned respective constructions function, respectively.

What is claimed is:

1. A method for bonding a sheet for a corrugated cardboard box comprising the steps of:
providing one set of two sheets for a corrugated cardboard box, in which a connecting flap projects on one side with a first folding line taken as a boundary and a flap to be connected (hereafter referred to only as a connected flap) corresponding to the connecting flap is formed on a rear surface of the other side, a second folding line being formed between the connecting flap and the connected flap, a connecting-flap side sheet and a connected-flap side sheet being provided between the first folding line and the second folding line and between the second folding line and the connected flap, respectively;
arranging one of the sheets for the corrugated cardboard box above in a horizontal state and the other sheet below and symmetric with respect the above-mentioned one sheet in the horizontal state and holding the position of either of the sheets;
folding the connecting flap of one of the sheets for the corrugated cardboard box downwardly at right angles with the first folding line taken as a boundary;
folding the connecting flap of the other sheet for the corrugated cardboard box upwardly at right angles with the first folding line taken as a boundary;
folding the connected-flap side sheet of one of the sheets for the corrugated cardboard box downwardly at right angles with the second folding line taken as a boundary;
folding the connected-flap side sheet of the other sheet for the corrugated cardboard box upwardly at right angles with the second folding line taken as a boundary to form the both sheets into a position rectangular in section and providing threading portions, each of which comprises the respective connecting flap and the connected flap opposing to each other, on a diagonal line and holding their positions as they are;
arranging two sets of sewing machines each of which comprises a sewing-machine needle mechanism provided with a horizontally movable sewing-machine needle and a looper mechanism having a needle plate;
setting the needle plate of the looper mechanism inside one of the threading portions and the sewing-machine needle mechanism outside the other of the threading portions; and
stitching each of the threading portions with threads by intermittently moving the both sheets, each formed in a rectangular shape in section, for the corrugated cardboard box in parallel to the first folding line and the second folding line and synchronizing the sewing-machine needle with the intermittent movement to reciprocally move it from the outside to the inside of the threading portion.

2. An apparatus for bonding a sheet for a corrugated cardboard box comprising:
an upper transporting means and a lower transporting means for vertically dividing one set of two sheets for the corrugated cardboard box, respectively, in which a connecting flap projects on one side with a first folding line taken as a boundary and a connected flap corresponding to the connecting flap is formed on a rear surface of the other side, a second folding line being formed between the connecting flap and the connected flap, a connecting-flap side sheet and a connected-flap side sheet being provided between the first folding line and the second folding line and between the second folding line and the connected flap, respectively, and transporting the thus divided sheets in a horizontal direction,
an upper position-control means and a lower position-control means provided at the respective positions at least scheduled to be folded, respectively in the one set of two sheets for the corrugated cardboard box;
an assembly which comprises an upper connecting-flap folding means for folding the connecting flap and an upper connected-flap side sheet folding means for folding the connected-flap side sheet with the respective first and second folding lines in each of the both sheets for the corrugated cardboard box taken as boundaries;
another assembly which comprises a lower connecting-flap folding means for folding the connecting flap and a lower connected-flap side sheet folding means for folding the connected-flap side sheet provided on a diagonal line and symmetric with respect to the above-mentioned assembly;
an upper intermittent moving means for intermittently moving the both sheets for the corrugated cardboard box provided on a diagonal line and symmetric with respect to the upper intermittent moving means;
a lower intermittent moving means for intermittently moving the both sheets for the corrugated cardboard box provided on a diagonal line and symmetric with respect to the upper intermittent moving means;
an upper sewing machine which comprises a sewing-machine needle mechanism provided with a horizontally movable sewing-machine needle and a looper mechanism having a needle plate;
a lower sewing machine which comprises a sewing-machine needle mechanism provided with a horizontally movable sewing-machine needle and a looper mechanism having a needle plate and is provided on a diagonal line and symmetric with respect to the upper sewing machine;
the needle plate of each of the looper mechanisms being provided inside the connecting flap scheduled to be thread-stitched and each of the sewing-machine needle mechanisms being arranged outside the connected flap scheduled to be thread-stitched; and
synchronizing the sewing-machine needle with the intermittent movement of the intermittent moving means to reciprocally move it in a horizontal direction from the outside of the connected flap to the inside connecting flap so as to stitch the threading portion, which comprises the connecting flap and the connected flap, with threads.

3. The apparatus for bonding the sheet for the corrugated cardboard box as set forth in claim 2, wherein the upper connected-flap side sheet folding means for folding the connected-flap side sheet is provided vertically movable as well as the upper position-control means near the upper connected-flap side sheet folding means;
the upper transporting means is provided vertically movable and has its widthwise spacing adjustable;
the upper intermittent moving means, the upper sewing machine, the upper connecting-flap folding means for folding the connecting flap, and the upper position-control means near the upper connecting-flap side sheet folding means are provided vertically and horizontally movable, respectively ;
the lower connected-flap side sheet folding means for folding the connected flap side sheet, and the lower position-control means near the lower connected-flap side sheet folding means are provided horizontally movable, respectively ; and
the lower transporting means has its lengthwise spacing adjustable.
